(19) United States
(12) Patent Application Publication
(10) Pub. No.: US 2003/0061039 A1
(43) Pub. Date: Mar. 27, 2003

(54) Interactive voice-operated system for providing program-related sevices

(76) Inventor: Alexander Levin, Livingston, NJ (US)

Correspondence Address: Howard M. Cohn, 21625 Chagrin Blvd. Suite 220, Cleveland, OH, 44122, US

(21) Appl. No.: 10/253,131

(22) Filed: Sep. 24, 2002

Related U.S. Application Data
(60) Provisional application No. 60/324,488, filed on Sep. 24, 2001.
(60) Provisional application No. 60/324,489, filed on Sep. 24, 2001.
(60) Provisional application No. 60/324,491, filed on Sep. 24, 2001.
(60) Provisional application No. 60/324,492, filed on Sep. 24, 2001.

(51) Int. Cl. G10L 17/00

(52) U.S. Cl. 704/246

(57) ABSTRACT

A system is described that allows a user to query a database of TV and/or radio program listings using natural language, spoken commands. The system guides the user and responds with spoken, natural language prompts and responses. Types of queries can include, but are not limited to: a program name, broadcast time, broadcast date, program description (i.e., theme, e.g., drama, comedy, horror, suspense, etc.), channel number(s), channel name(s) and/or any other searchable program listing parameter. Responses to user queries by the system will include information related to the query, utilizing text-to-speech technology, and/or recorded prompts. The user of the system can communicate with the system via a telephone or a telephone-like device, such as an integrated remote-control and wireless telephone device, wireless telephone devices, personal assistant, IP telephone, personal computer or any other device having access to communications networks and having phonelike input/output capabilities. The system receives the voice information by any suitable communications means, such as a PSTN (Public Switched Telephone Network), the Internet (via any suitable Internet voice communications mechanisms), LAN, WAN, cable, or any other suitable wired or wireless communications network.

Additionally, the system can combine conventional remote control functions with the function of a wireless telephone device to establish voice communication with a remote automated voice recognition and response system. The user interacts with the voice recognition and response system in natural language to access programming information, pay-per-view services, to purchase merchandise, to schedule a program selection, etc.

### CROSS-REFERENCE TO RELATED APPLICATIONS

This application claims the benefit of U.S. Provisional Patent Application Nos. 60/324,488, 60/324,489, 60/324,490, 60/324,491, and 60/324,492, filed Sep. 24, 2001 by Levin.

### TECHNICAL FIELD

The present invention relates generally to voice operated systems and more particularly to voice operated information retrieval devices.

### BACKGROUND ART

Over the last few decades, television media, particularly satellite and cable television, have become increasingly sophisticated and diverse in the number and scope of their program offerings. Even television devices themselves have changed greatly in their capabilities.

Along with this sophistication, however, has come unprecedented complexity—especially in the area of user interface. A few decades ago, a television with a remote control was considered somewhat of a luxury, and the remote controls did little more than change channels and adjust volume. The once-simple television remote control has now become a highly complicated control center with dozens of buttons. This is especially true of “integrated” remote controls that operate numerous devices, such as DVD players, VCR's, cable or satellite converter boxes, audio systems and televisions. Such devices often feature complicated layouts of multi-function buttons that are often incomprehensible to the average user.

One of the greater challenges of television service providers (e.g., satellite TV and cable TV providers) is to make the customer aware of their offerings and to make those offerings readily available in ways that will encourage the customer to take advantage thereof. User-interface complexity (e.g., complicated remote controls) tends to discourage the customer from making use of the provider's offerings. Further complicating matters is that the television viewer (customer) must deal with remote control devices at night and/or in low-light conditions where complexity is compounded by an inability to see the remote control device clearly.

In an attempt to make programming more accessible to their customers, television service providers added non-interactive program-guide channels on which program information would be displayed in a scrolling or paged format, repeating periodically. This worked well up to a point, but as the number of offerings grew, so did the length of the program listings on these program guides. With the current diversity of program offerings, most such program guide channels require many minutes for the entire program listing to scroll or page through and repeat itself. This results in frustratingly long waits for viewers waiting for the next program listing cycle to complete so that they can see the program listings for the channels they are interested in.

A further limitation of the scrolling/paged program guide channels is that they offer program information for only a limited “window” of time. It is not possible, for example, to examine listings eight or ten hours in advance, nor is it possible to look backwards to find the name of a movie that just finished playing.

As cable and satellite converter boxes have become more sophisticated, service providers have address some of these deficiencies and limitations by offering interactive program guides, allowing the television viewer (customer) to use his remote control to navigate through an interactive on-screen program guide directly to the listings of interest. Further, such interactive guides permit selecting a time and/or date for program listing information, overcoming one of the aforementioned limitations. However, the addition of interactive program guide capability has required the addition of navigation functions to already-overloaded remote control devices.

Although service providers are constantly looking for new products and services to give them a competitive advantage in the increasingly crowded television marketplace, user-interface complexity presents a significant obstacle to be overcome. Viewers (customers) are unlikely to make use of a service or feature if it is overly difficult to access.

Evidently, there is a need for an improved and simplified form of interface to services and features offered by television service providers.

### SUMMARY OF THE INVENTION

The present invention simplifies interaction with television services and features by means of an interactive voice recognition and response system. Speech is the most natural method of communication between people. Creating machines that understand the human voice has been a monumental challenge for scientists and the focus of intensive research for several decades. The recent development of reliable and efficient speech recognition technologies, especially continuous speech recognition technology, has made useful interactive voice recognition and response systems practical.

The present invention provides a system that will allow a user to query a database of TV and/or radio program listings using natural language, spoken commands. The system guides the user with spoken, natural language prompts and responses and provides the information requested by the user. Types of queries can include, but are not limited to: a program name, broadcast time, broadcast date, program description (i.e., theme, e.g., drama, comedy, horror, suspense, etc.), channel number(s), channel name(s) and/or any other searchable program listing parameter. Responses to user queries by the system will include information related to the query, utilizing text-to-speech technology, and/or recorded prompts. The user of the system can communicate with the system via a telephone or a telephone-like device, such as an integrated remote-control and wireless telephone device, wireless telephone devices, personal assistant, IP telephone, personal computer or any other device having access to communications networks and having phone-like input/output capabilities. The system receives the voice information by any suitable communications means, such as a PSTN (Public Switched Telephone Network), the Internet (via any suitable Internet voice communications mechanisms), LAN, WAN, cable, or any other suitable wired or wireless communications network.

Further, the present inventive technique combines conventional remote control functions with the function of a wireless telephone device to establish voice communication with a remote automated voice recognition and response system. The user interacts with the voice recognition and response system in natural language to access programming information, pay-per-view services, to purchase merchandise, to schedule a program selection, etc.

The remote control device is essentially a combined wireless/cordless telephone combined with a conventional television/radio remote control. The “base unit” (e.g., set-top box) for the remote control device integrates a conventional command unit (e.g., set-top cable box) with a cordless telephone base unit. Preferably, the command unit and cordless telephone base unit will share a common network connection, although it is fully within the spirit and scope of the present invention to provide separate connections for each (e.g., a cable television connection for the command unit and a telephone network connection for the wireless telephone base.)

The case where a cable television provider also provides cable Internet services is particularly advantageous in the context of the present inventive technique, since the wireless telephone base unit can be implemented as an Internet telephone device sharing a common physical connection to the television cable, thereby eliminating the need for a separate telephone network connection.

Further, the present invention provides a system that will allow a user to query a database of TV and/or radio program listings using natural language, spoken commands. The system guides the user with spoken, natural language prompts and responses and provides the information requested by the user. Types of queries can include, but are not limited to: a program name, broadcast time, broadcast date, program description (i.e., theme, e.g., drama, comedy, horror, suspense, etc.), channel number(s), channel name(s) and/or any other searchable program listing parameter. Responses to user queries by the system will include information related to the query, utilizing text-to-speech technology, and/or recorded prompts. The user of the system can communicate with the system via a telephone or a telephone-like device, such as an integrated remote-control and wireless telephone device, wireless telephone devices, personal assistant, IP telephone, personal computer or any other device having access to communications networks and having phone-like input/output capabilities. The system receives the voice information by any suitable communications means, such as a PSTN (Public Switched Telephone Network), the Internet (via any suitable Internet voice communications mechanisms), LAN, WAN, cable, or any other suitable wired or wireless communications network.

According to an aspect of the invention, program-on-demand services can be ordered by using the same voice recognition and response techniques described hereinabove to receive payment for a program and to verify billing information from the user. Upon completion of payment, the system directs a program streaming system or device to provide the program to the user.

According to another aspect of the invention, program-related goods and/or services can be ordered by using natural language dialogue to identify a product or service and to collect billing information from the user by the same interactive process of natural-language dialogue.

According to another aspect of the invention, the system can play short “voice banner” advertisements at selected times during an interactive natural-language dialogue with a user, preferably in-between utterances and/or while information is being retrieved. Additionally, the “voice banners” can be selected based upon specific data stored in a user profile.

According to another aspect of the invention, a remote control device having a speaker and a microphone is used to control a user's viewing or listening device (e.g., a television or radio), and to interact with an interactive voice recognition and response system. The remote control device forwards voice signals to and receives responses from the voice recognition and response system.

According to another aspect of the invention, a database of program listing information is made accessible to the interactive voice recognition and response system. This facilitates interactive voice queries of the program-listing database via the remote control device.

According to another aspect of the invention, the remote control device can include a wireless telephone device. In this case, the interactive voice recognition and response system is connected to a telecommunications network (e.g., telephone network), and the remote control device accesses the interactive voice recognition and response system by establishing a connection thereto via the telecommunications network.

According to another aspect of the invention, a database query system is provided so that the voice recognition and response system can query one or more databases (e.g., program-listing, products, services, advertisements, etc.) and provide responses.

According to another aspect of the invention, items stored in the database(s) can be selected based upon a currently selected program.

According to another aspect of the invention, items stored in the database(s) can be selected based upon user-profile information stored in a user-profile database.

### BRIEF DESCRIPTION OF THE DRAWINGS

These and further features of the present invention will be apparent with reference to the following description and drawing, wherein:

FIG. 1 is a block diagram of an interactive, voice operated program information retrieval system, according to the invention.

FIG. 2 is a block diagram of an interactive, voice operated information retrieval and ordering system, according to the invention.

In the detailed description that follows, identical components have been given the same reference numerals, regardless of whether they are shown in different embodiments of the present invention. To illustrate the present invention in a clear and concise manner, the drawings may not necessarily be to scale and certain features may be shown in somewhat schematic form.

### DETAILED DESCRIPTION OF THE INVENTION

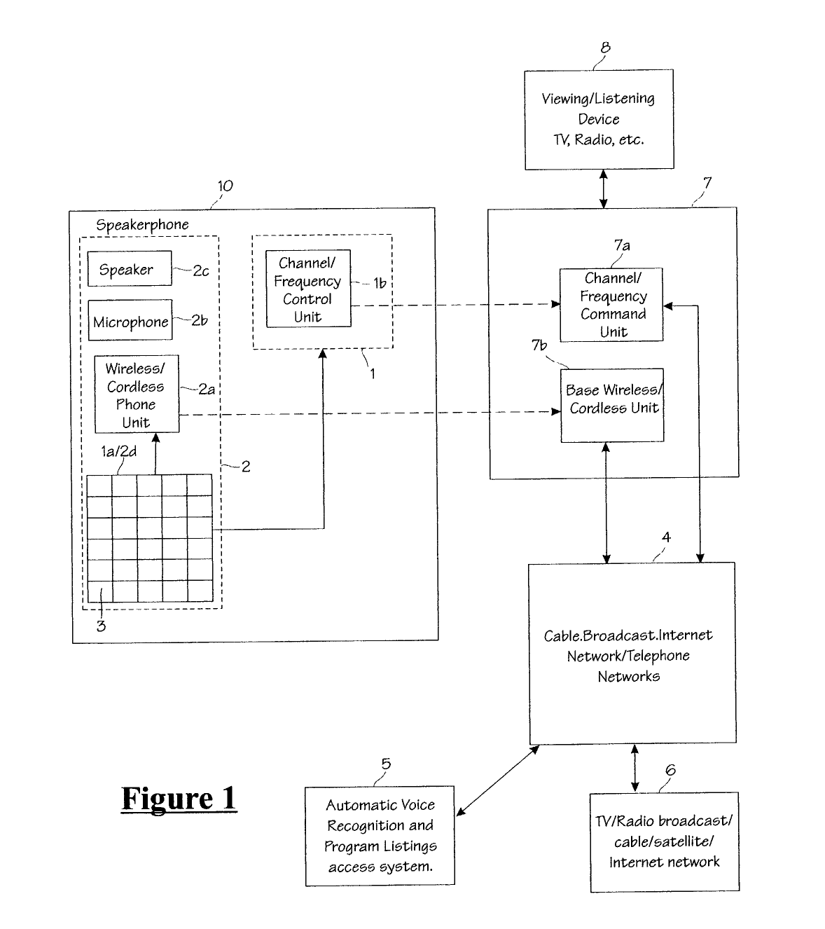

FIG. 1 shows a block diagram of an interactive, voice-operated information retrieval system, according to the invention. The system comprises an integrated remote control device 10, a controller device 7, a communications network 4, and an automatic voice recognition and program listings access system 5.

The integrated remote control device 10 comprises a wireless remote control unit 1, and a wireless telephone unit 2. The wireless remote control unit further comprises a user input device 1a and a wireless remote transceiver unit (channel/frequency control unit) 1b. The wireless telephone unit further comprises a wireless telephone transceiver 2a (wireless telephone control unit) a microphone 2b, a speaker 2c and a user input device 2d.

In the Figure, the user input device 1a for the wireless remote control unit 1 and the user input device 2d of the wireless telephone unit 2 are integrated into a single user input device (1a/2d), although it is within the spirit and scope of the present invention for them to be separate. Preferably, the user input device (1a/2d) is a keypad device or touchscreen display.

The controller device 7 comprises a wireless remote command unit 7a and a base wireless telephone unit 7b. The wireless command unit 7a acts as a set-top box, responsive to commands received wirelessly from the wireless remote transceiver unit 1b to select television/radio frequency and to perform other television/radio functions (e.g., adjust volume, tone, etc.). The base wireless telephone unit 7b communicates with the wireless telephone transceiver 2b in the same way as a wireless telephone bas unit communicates with its portable handset, thereby providing means of voice communication.

The wireless command unit receives television and/or radio transmissions from a program signal source 6 (TV/Radio broadcast/cable/satellite/Internet network) via an aspect of the communications network 4, preferably a cable television network or satellite television link. The base wireless telephone unit 7b connects to another aspect of the communications network 4, preferably a switched telephone network. Alternatively, the wireless base telephone unit 7b can connect to a data network or the Internet, thereby providing the functions of an internet telephone. In the event that television signals are being provided by a cable service provider that also provides cable Internet services, an Internet connection for the wireless base telephone unit 7b can be particularly advantageous, since it eliminates the need for a second physical network connection.

By means of its network connections, the wireless base telephone unit 7b can connect to an automated voice recognition and response unit 5 (automated voice recognition and program listings access system), thereby establishing voice communication between the automated voice recognition and response system 5 and a user of the integrated remote control device 10. A digital speech processing system in the automated voice recognition and response system 5 interacts with the user in natural language to respond to user requests for information, such as program listings, pay-per-view authorization, etc.. By means of an aspect of the communications network 4, preferably an Internet connection, the automated voice recognition and response system 5 can direct the program signal source to provide requested information or programming to the wireless remote command unit 7a for display or playback on a receiver 8, preferably a television or radio receiver. The receiver 8 can also be a computer suitably equipped to receive radio or television program information.

Optionally, a dedicated button 3 (or dedicated touch spot on a touchscreen display) can be used to establish communication with the automated voice recognition and response system.

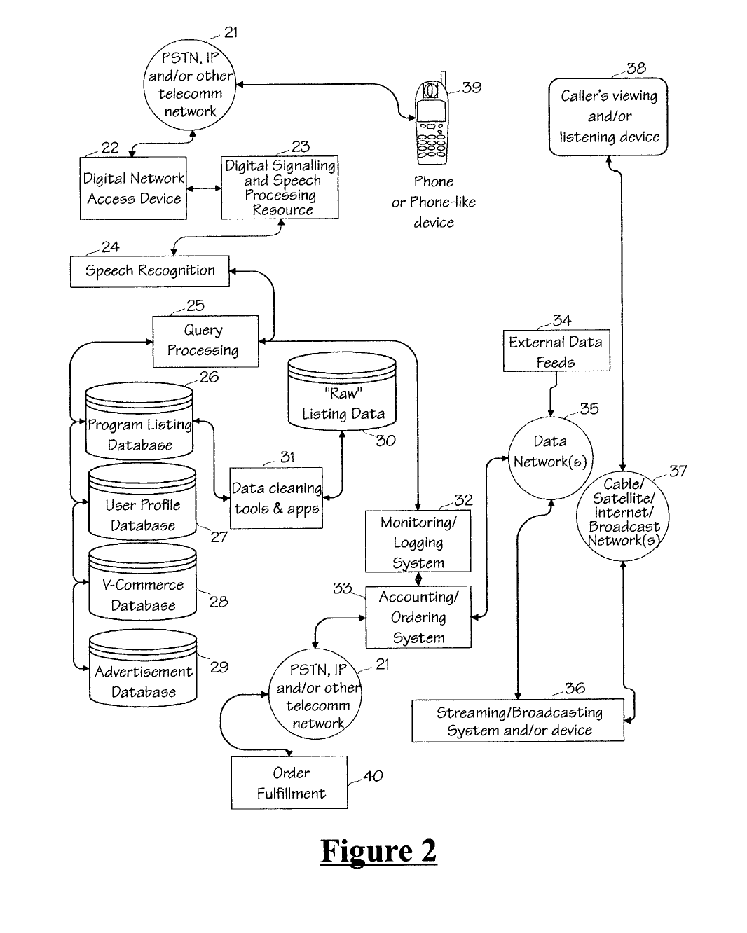

FIG. 2 shows a block diagram of an interactive, voice-operated information retrieval and ordering system, according to the invention. A user employs a telephone or telephone-like device 39 to communicate via a telecommunications network 21 to a digital network access device 22 that communicates in turn with a digital signaling and speech processing resource 23 to establish a voice connection to a speech recognition resource 24. The digital signaling and speech processing resource responds to network signaling (e.g., touch-tone presses, Caller ID, etc.). Caller ID can be used to identify the user and to retrieve a user's account number(s) and to retrieve an appropriate user profile. The speech recognition resource 24 analyzes utterances spoken by the user and translates them into digital representations of those utterances. The digital signaling and speech processing resource 23 provides the capability of spoken voice responses to the user by means of text-to-speech synthesis techniques.

A query-processing engine 25 operates on the translated utterances to query one or more databases. These databases can include, but are not limited to:

a program listing database 26 containing information regarding program start times, durations, broadcast dates, titles, actors, genre, etc.

a user profile database 27 containing information “learned” about the user based upon previous selections and queries made by that user and cross-reference links to other databases, such as links to specific products and/or services related to certain user profile characteristics

a “V-commerce” or “video” commerce database 28 containing information about products, vendors, and services and cross-reference links other databases, such as links to program listings related to those products, vendors and services

an advertisement database 29 containing short spoken “banner ads” or “voice banners” provided by sponsors for products and services, and cross-reference links to other databases, such as links between specific “banner ads” and specific user profile characteristics.

A “raw listings” database 30 from a program listing provider service provides the basic material used to populate the program listing database 26. Data “cleaning” tools and applications 31 are used to re-format, cross-reference and organize data from the “raw listings” database 30 for storage in the program database.

A monitoring/logging system 32 keeps track of user requests and routes user requests to purchase products and/or services to an accounting/ordering system 33 that handles fund transfers and payments (e.g., credit card payments, direct debit, charges to a cable TV or telephone account, etc.). The accounting/ordering system then forwards completed and verified orders via any suitable telecommunications network 21 to an order fulfillment system 40 that processes and fills the order. Examples of products and services that can be ordered include:

pay-per-view (PPV) or video-on-demand (VOD) programming

products (e.g., logo tote bags, video tapes, action figures, books and other goods) related to a particular program or movie

addition of premium cable/satellite services (e.g., HBO, SHO, TMC, MAX, etc.)

In the case of PPV and/or VOD programming, the accounting/ordering system 33 communicates via one or more data networks 35 to a streaming/broadcasting system or device 36 to provide the requested programming, routing it via a suitable cable, satellite, internet or broadcast network 37 to a user's viewing and/or listening device 38, such as a television or radio. Where the requested programming originates from a source external to the local service provider, the streaming/broadcasting system and/or device 36 receives the requested programming via a suitable transmission medium (data network 35 shown) and forwards it to the user via the aforementioned network(s) 37.

General TV/Radio Program Listings Search and Retrieval

The user can places a call to the system using a phone or any phone-like device 39. The system greets the user with a welcome message and menu of possible search and help options. The user speaks his choice of menu, or presses an appropriate button on his phone or phone-like device 39. Using the speech recognition engine 24 and related applications the system analyzes in order to recognize and to process the user's spoken query. After the system analyzes and confirms a user's query, the system responds by navigating menus and or performing a search of the TV and/or radio program database 26 to retrieve all relevant matching records. The system and the user engage in a natural-language spoken dialog as required to refine the user's query. The system retrieves the results ordered such that best matches occur first. In the event of an excessive number of matches, the system offers to filter the list of results according to a predetermined or user-specified set of criteria. The user can change or refine his selection at any time by interrupting the systems spoken responses with a further voice command, or by pressing an appropriate button on his phone or phone-like device 39. Among the set of possible user search options are:

search by full program name

search by partial program name

search by alternative short name

search by names of actors, directors, producers or other participants

The results of the search produce information related to the broadcast time, date, and channel or frequency, properly referenced to the user's location and TV or radio programming provider. In addition the system will offer to read supplemental information about the program, such as program description, participating actors, program production year, and any other relevant information stored in the listings database 26.

The caller's location can be automatically obtained by getting his “caller ID” and/or ANI and/or DINA from the telephone provider. In the event such information can not be obtained automatically the caller will be asked by the system for his postal code, and/or phone number. In addition caller can be asked for the name of his TV or radio service provider.

The user's phone number, location and provider will be stored in the system logs and/or database in order to minimize the number of dialog utterances required in subsequent uses of the system.

In the event of a failure to recognize a user's spoken request during the dialog, the system recovers by entering a recovery dialog were the user is asked to rephrase this query, or to make some other selection, or to make a new query.

TV and/or Radio Listings Search by Program Name

To retrieve program listing information by program name, the user speaks the appropriate phrase (e.g., “search by name”) and the system dialog asks the user to speak the program name and offers to read all relevant matches found in the program listing database 26. By way of example, each program air time and channel number can be read to user in one continuous utterance. Upon hearing the desired time, the user can select it by making a suitable utterance (e.g., “Yes, pick that one”) or can cancel the search by pressing an appropriate button or by making a suitable utterance (e.g., “Stop reading”). After the user selects a specific program and air time, the system can offer to read additional and supplemental information about the program.

TV and/or Radio Listings Search by Program Category

Similarly, program listings can be searched by program category (e.g., type or genre, such as Romance, Drama, Horror, Science Fiction, etc.). The user makes the appropriate menu selection by speaking an appropriate phrase (e.g., “search by category”), and the system makes interacts with the user as required to narrow down the choices. As before, once the user has made a selection, the system can offer to provide additional and/or supplemental information about the program.

TV and/or Radio Listings Search by Channel and Time Period

Again, in similar fashion, program listings can be searched by channel number and/or time period. As before, the user selects the appropriate search “mode” by making an appropriate natural language utterance, and the system interacts with the user as necessary to identify a specific program selection. Once the user has made a selection, the system can offer to provide additional and/or supplemental information about the program.

Order of TV and/or Radio Program on Demand

In addition to simple program listing searches, the present inventive system can be used to facilitate selection and ordering of “Fee-for-service” programming, such as TV-on-demand, video-on-demand, pay-per-view, and/or radio-on-demand. Proliferation of program on demand services such as these has created thousand of choices for consumers. The navigation of these choices is becoming very cumbersome and complex. By employing the present inventive system to facilitate selection and order of “program-on-demand” services, much of the complexity is reduced. The desired programming would be selected in much the same manner as that describe hereinabove, but at the end of the selection the user is offered the opportunity to purchase the program or to “quit”.

In a natural-language dialogue, the system requests user credit card information or account information. If the user has ordered products and/or services previously (including program-on-demand services) then his credit card, account, and/or billing information may be on file, reducing the need for excessive dialogue. For example, if the user says “Charge to my VISA card”, and the user's credit card information is on file, then the system can automatically retrieve the information and ask the user for verification/validation.

The system then forwards the request to the streaming/broadcasting system and/or device (36), which in turn either “cues up” or schedules transmission of the requested program to the user.

V-Commerce

The present inventive system is also useful for ordering program-related goods and/or services. Some examples of such items are:

program transcript

program recordings on DVD, Video Cassette, CD or other format

program-related merchandise (e.g., “logo” items, tools, action figures, etc.)

program-related books and further references

By cross-referencing the V-commerce database with the program listing database, the present inventive system can recommend items to the user (or the user can select items) based on the selected program. For example, if a documentary is aired for which an offer is made to sell a video cassette of the program, the user can “call up” the system via his phone or phone-like device, identify the program, and speak an appropriate phrase (e.g., “I want to buy the video cassette”), in response to which the system will confirm the program selection and ordered item and request billing information from the user. The user can then pay for the item via credit card, direct debit, billing to an account, or other suitable method. As before, the system interactively prompts the user to make the necessary choices and to provide the required information. Upon completion of the order (via the accounting/ordering system (33), as before) the request is forward to an order fulfillment system (40) for delivery to the user.

Advertisement

At selected times during an interactive natural-language dialogue with a user, the system can play short “voice banners”, analogous to web “banner ads”, wherein a short message can be read, preferably in-between utterances and/or while information is being retrieved. Additionally, the “voice banners” selected based upon specific data stored in a user profile. For example, if a user shows a preference for historical programming, then advertisements for vendors whose products are related to historical programming can be played. Alternatively, if a user shows a preference for “do-it-yourself” programming, then “voice banners” related to tools, home improvement and the like can be played.

Although the invention has been shown and described with respect to a certain preferred embodiment or embodiments, it is evident that equivalent alterations and modifications will occur to others skilled in the art upon the reading and understanding of this specification and the annexed drawings. In particular regard to the various functions performed by the above described components (assemblies, devices, circuits, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

What is claimed is:

1. An interactive, voice operated information retrieval system, comprising:
a remote control device having a speaker and a microphone;
a controller device for communicating with the remote control device; and
an interactive voice recognition and response system; wherein:
said controller device forwards voice signals to and receives voice responses from said interactive voice recognition and response system.

2. A system according to claim 1, further comprising:
a database of program listing information accessible to said voice recognition and response system.

3. A system according to claim 1, wherein:
said remote control device includes a wireless telephone device; and
said voice recognition and response system is connected to a telecommunications network for communicating via natural-language dialogue with a user via the integrated remote control and telephone device.

4. A system according to claim 1, further comprising:
a query system, responsive to queries submitted via the voice recognition and response system to query the database and to provide responses via the voice recognition and response system.

5. A system according to claim 1, further comprising:
a database of program-related merchandise and services accessible to the voice recognition and response system.

6. A system according to claim 5, further comprising:
a user-profile database accessible to the voice recognition and response system.

7. A system according to claim 6, further comprising:
means for selecting items from the database of program-related merchandise and services according to user-profile data stored in the user-profile database.

8. A system according to claim 1, further comprising:
an advertisement database accessible to the voice recognition and response system.

9. A system according to claim 8, further comprising:
a user-profile database accessible to the voice recognition and response system.

10. A system according to claim 9, further comprising:
means for selecting items from the advertisement database according to user-profile data stored in the user-profile database.

11. An interactive, voice operated system for ordering program-related products and services, comprising:
a voice recognition and response system connected to a telecommunications network;
a database of program listing information;
a query system, responsive to queries submitted via the voice recognition and response system to query the database and to provide responses via the voice recognition and response system;
an order processing system, responsive to the voice recognition and response system for receiving and verifying billing information; and
means, responsive to the order processing system, for providing a requested product/service.

12. A system according to claim 11, further comprising:
a database of program-related products/services;
means for presenting selected items from the database of program-related products/services via the voice recognition and response system, based upon a currently selected program.

13. A system according to claim 11, further comprising:
a database of program-related products/services;
a user-profile database; and
means for presenting selected items from the database of program-related products/services via the voice recognition and response system, based upon information stored in the user-profile database.

14. A system according to claim 11, further comprising:
an advertisement database;
means for presenting selected items from the advertisement database, based upon a currently selected program.

15. A system according to claim 11, wherein:
the advertisement database contains “voice banned” ads.

16. A system according to claim 11, further comprising:
an advertisement database;
a user-profile database; and
means for presenting selected items from the advertisement database via the voice recognition and response system, based upon information stored in the user-profile database.

17. A system according to claim 16, wherein:
the advertisement database contains “voice banned” ads.

18. A method of retrieving information from a network, comprising:
providing an integrated remote-control transceiver and telephone device;
providing an interactive voice recognition and response system;
providing a controller device for connecting to said interactive voice recognition and response system and for communicating with said integrated remote control transceiver and telephone device;
operating said integrated remote control transceiver to establish voice communication with said interactive voice recognition and response system via said controller device

19. A method according to claim 18, further comprising:
providing a program-listing database accessible via the interactive voice recognition and response system.

20. A method according to claim 18, further comprising:
providing a database of program-related products/services, accessible via the voice recognition and response system.

21. A method according to claim 18, further comprising:
providing an advertisement database, accessible via the voice recognition and response system.
